(19) United States
(12) Patent Application Publication
(10) Pub. No.: US 2014/0189202 A1
(43) Pub. Date: Jul. 3, 2014

(54) STORAGE APPARATUS AND STORAGE APPARATUS CONTROL METHOD

(71) Applicant: Hitachi, Ltd., Tokyo (JP)

(72) Inventor: Fumiaki Hosaka, Odawara (JP)

(73) Assignee: Hitachi, Ltd., Tokyo (JP)

(21) Appl. No.: 13/810,837

(22) PCT Filed: Dec. 28, 2012
(86) PCT No.: PCT/JP2012/008424

§ 371 Date: Jan. 17, 2013

(51) Int. Cl. G06F 12/02

(52) U.S. Cl. CPC G06F 12/0246
USPC 711/103

(57) ABSTRACT

The access performance of a drive having a non-volatile memory is improved.

A storage apparatus is provided with a controller, a memory and a drive. When the drive information is decided to satisfy the first condition and the controller receives from the host computer a write request instructing the controller to update first data stored in the drive to second data, the controller transmits to the drive control device a first read command instructing the drive control device to read the first data from the non-volatile memory in accordance with the write request. After the transmission of the first read command, the controller transmits to the drive control device a first write command instructing the drive control device to write the second data to the drive in accordance with the write request.

### TECHNICAL FIELD

The present invention relates to a technique for controlling writing to a drive including a non-volatile memory.

### BACKGROUND ART

There is known a storage system which loads a drive including a non-volatile memory such as a flash memory in order to improve the system performance or the access performance. Improving the system performance with the non-volatile memory requires an access range or scheme to be optimized according to the characteristics of the drive.

In this regard, there is known a technique of specifying data to be pre-read through a pre-read command, reading the data from a flash memory and storing the data in a buffer memory (PTL 1).

### CITATION LIST

### Patent Literature

[PTL 1] Japanese Patent Laid-Open No. 2010-191983

### SUMMARY OF INVENTION

### Technical Problem

In a drive having a non-volatile memory such as a flash memory, data needs to be written into a free space. When the amount of write to the drive increases, with its memory running short of free space, the drive performs internal processing of generating free space through garbage collection or the like. When free space is generated during a write, the write performance of the drive deteriorates. This is because processing of physically erasing an area where unnecessary data exists and then recording new data requires more time than processing of directly recording data into free space. That is, such access performance of the drive deteriorates in the middle of use, producing a large difference between an initial state in which there is sufficient free space and a state in which there is little free space.

To prevent such performance deterioration, there is known Over Provisioning which, for example, reduces a logical capacity allocated to a flash memory, increases a free area in a pseudo-form and increases efficiency of garbage collection. However, performing Over Provisioning leads to an increase in the cost of the drive for securing a desired storage capacity.

### Solution to Problem

In order to solve the above-described problems, a storage apparatus which is an aspect of the present invention is provided with a controller coupled to a host computer, a memory coupled to the controller, and a drive coupled to the controller. The drive includes a drive control device coupled to the controller and configured to control the drive, and a non-volatile memory coupled to the drive control device. The memory is configured to store drive information including a situation of write to the drive. The controller is configured to decide whether or not the drive information satisfies a first condition. When the drive information is decided to satisfy the first condition and the controller receives from the host computer a write request instructing the controller to update first data stored in the drive to second data, the controller transmits to the drive control device a first read command instructing the drive control device to read the first data from the non-volatile memory in accordance with the write request. After the transmission of the first read command, the controller transmits to the drive control device a first write command instructing the drive control device to write the second data to the drive in accordance with the write request.

### Advantageous Effects of Invention

The storage apparatus which is an aspect of the present invention can improve access performance of a drive having a non-volatile memory.

### BRIEF DESCRIPTION OF DRAWINGS

FIG. 1 illustrates a configuration of a storage apparatus according to an embodiment of the present invention.

FIG. 2 illustrates a configuration of an SSD.

FIG. 3 illustrates contents of a drive management table.

FIG. 4 illustrates contents of a drive management table that manages RAID groups.

FIG. 5 illustrates contents of a condition management table.

FIG. 6 illustrates write mode determination processing.

FIG. 7 illustrates write mode execution processing.

FIG. 8 illustrates second mode processing.

FIG. 9 illustrates third mode processing.

FIG. 10 schematically illustrates third mode processing in RAIDS.

FIG. 11 illustrates a modification example of the third mode processing.

FIG. 12 illustrates IO information update processing.

### DESCRIPTION OF EMBODIMENTS

Hereinafter, embodiments of the present invention will be described with reference to the accompanying drawings.

In the following description, information of the present invention will be described with expressions such as “aaa table,” “aaa list,” “aaa DB” and “aaa queue,” but these items of information may also be expressed with other than a data structure such as table, list, DB and queue. For this reason, to indicate that the information does not depend on the data structure, “aaa table,” “aaa list,” “aaa DB”, “aaa queue” or the like may also be called “aaa information.”

Furthermore, expressions such as “identification information,” “identifier,” “name” and “ID” are used to describe contents of each item of information, but these are mutually interchangeable.

In the following description, a “program” may be assumed as the subject, but since the program is run by a processor to perform predetermined processing using a memory and a communication port (communication control device), the processor may be the subject in the description. Furthermore, the processing disclosed assuming the program as the subject, may be processing executed by a computer such as a management server or information processing apparatus. Furthermore, part or whole of the program may be implemented by dedicated hardware.

Furthermore, various programs may be installed in a storage apparatus by a program delivery server or computer-readable storage medium.

Hereinafter, a storage apparatus of the present embodiment will be described.

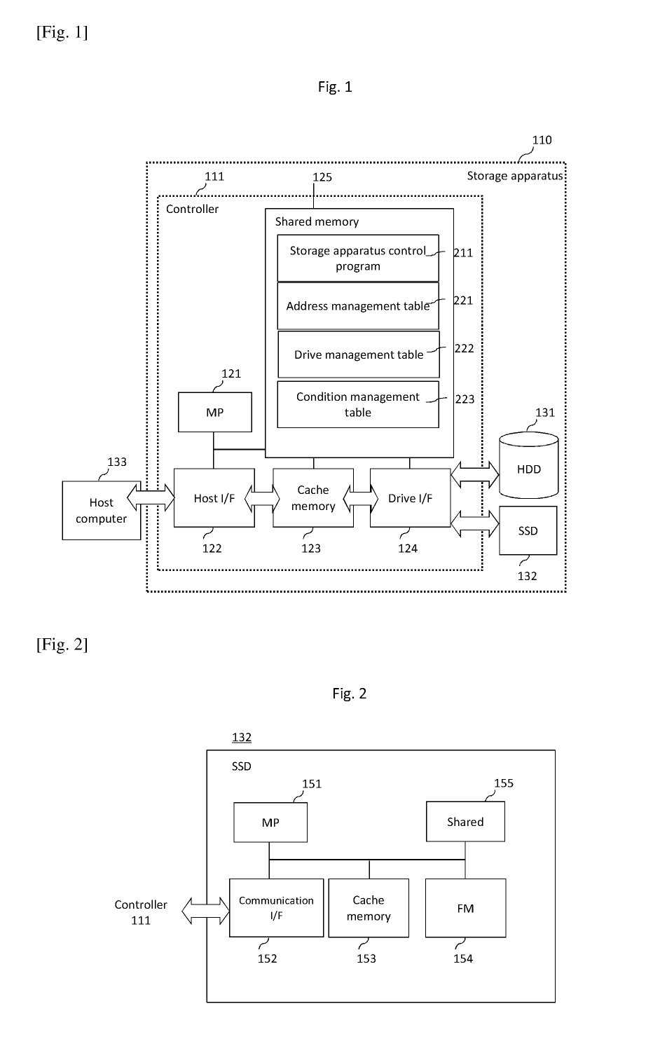

FIG. 1 illustrates a configuration of the storage apparatus according to an embodiment of the present invention. A storage apparatus 110 shown in FIG. 1 includes a storage control apparatus 111, an HDD 131 and an SSD (Solid State Drive) 132. Hereinafter, the HDD 131 and the SSD 132 will each be called “drive.” The storage control apparatus 111 is coupled to a host computer 133, receives an IO request from the host computer 133 and controls the drive. The storage control apparatus 111 includes an MP (Microprocessor) 121, a host I/F (Interface) 122, a cache memory 123, a drive I/F 124 and a shared memory 125. The storage apparatus 110 may also include a plurality of SSDs 132. The storage apparatus 110 may also include a plurality of HDDs 131 or may not include any HDD 131.

The host I/F 122 is coupled to the host computer 133 and controls communication with the host computer 133. The cache memory 123 stores write data from the host computer 133 to the drive or read data from the drive to the host computer 133. The drive I/F 124 controls communication between the cache memory 123 and the drive.

The shared memory 125 stores a storage apparatus control program and data to control the storage apparatus 110. The MP 121 controls the storage apparatus 110 according to the storage apparatus control program in the shared memory 125. The shared memory 125 further stores an address management table 221, a drive management table 222 and a condition management table 223. The address management table 221 shows the association between a logical address, RAID group, stripe, strip, drive or address in the drive and address in the cache memory 123 or the like. The drive management table 222 shows drive information containing a situation of write to each drive. The condition management table 223 shows conditions to determine operation of each drive.

The MP 121 creates a RAID group using a plurality of drives. The MP 121 configures a RAID level or a usage definition region or the like for the RAID group. The RAID level is 1, 5, 6 or the like. The usage definition region is a region assigned to logical addresses among storage regions in the drive. For example, the usage definition region is a region assigned to the RAID group.

The MP 121 determines a write mode indicating operation of write processing based on a situation of write to the drive or the like. The write mode indicates any one of a first mode, second mode and third mode. The first mode is normal write processing. In the second mode, a dummy read command is issued to the SSD 132 followed by issuance of a write command. In the third mode, a read command is issued to the SSD 132, followed by issuance of an erasure command and then issuance of a write command. When the RAID group is created using a plurality of SSDs 132, the MP 121 determines a write mode for each RAID group.

Hereinafter, the SSD 132 will be described.

FIG. 2 shows a configuration of the SSD 132. The SSD 132 includes an MP 151, a communication I/F 152, a cache memory 153, an FM (Flash Memory) 154, and a shared memory 155. The shared memory 155 stores a program and data to control the SSD 132. The MP 151 controls the SSD 132 according to the program in the shared memory 155. The communication I/F 152 is coupled to the drive I/F 124 to control communication with the drive I/F 124. The cache memory 153 stores read data from the FM 154 and write data to the FM 154. The FM 154 is a non-volatile memory such as NAND flash memory. The FM 154 may also be any other write-once read-multiple memory.

The MP 151 uses a page and a block as a unit to manage data. When writing a file to the FM 154, the MP 151 assigns a storage region in the FM 154 to each file in page (e.g., 8 KB) units. When erasing data in the FM 154, the MP 151 erases the data based on the unit of a block (e.g., 512 KB) which is integrated from a plurality of pages.

Rewrite processing for the SSD to rewrite stored data, for example, specifies a page storing pre-update data to be rewritten and a block containing the page, saves data corresponding to other pages in the specified block, erases the specified block and writes the updated data and the saved data to the specified block. Since a delay in such rewrite processing increases, during the rewrite processing, the MP 151 writes the updated data to an unused page in a block different from the pre-update page and changes a pointer indicating the address of the pre-update page to the updated page. When small-volume data is rewritten, this suppresses processing of rewriting an entire block. The page storing the pre-update data is left as a used page as is for the time being, but when many random writes of small-volume data occur, the SSD runs short of unused pages.

When the SSD 132 runs short of unused pages and a predetermined execution condition based on the number of unused pages is established, the MP 151 performs garbage collection which is internal processing of the SSD 132. Garbage collection may be called “reclamation.” In garbage collection, the MP 151 copies valid data from a target block including the used page to another block, releases and initializes the target block so as to convert pages in the target block to writable unused pages. When it is determined that an execution condition has been established, the MP 151 executes garbage collection as background processing during an idle or read time. The operation of background processing differs depending on the type of the SSD 132. As the execution condition, the amount of reserved region, amount of data written and frequency of writing or the like are used.

The drive using a NAND flash memory such as the SSD 132 or USB (Universal Serial Bus) memory has a reserved region. The MP 151 regards a block containing a sector where many bit errors have occurred as a defective block and invalidates the block. In this case, since the logical capacity recognizable from the host computer 133 cannot be reduced, the MP 151 compensates for the invalidated block from the reserved region so that the logical capacity does not decrease. When blocks are invalidated one after another until the reserved region becomes empty, the SSD 132 comes to an end of its life span. When a comparison is made between products having the same total amount of NAND flash memory, products having more reserved regions have longer life spans, but the cost of the device relative to the logical capacity increases. Furthermore, the more reserved regions the product has, the more unused pages are prepared for writing, which results in an effect of suppressing deterioration of performance.

The SSD 132 can use Over Provisioning which increases reserved regions to prevent deterioration of performance. For example, assuming the physical capacity of the SSD 132 is 500 GB, the logical capacity is 400 GB, and the amount of reserved region is 100 GB, if the SSD 132 is formatted by writing “0”s, the logical capacity of 400 GB is filled with “0”s. For that reason, the formatted unused page becomes 100 GB of the reserved region. When this 100 GB is written, the unused page becomes 0, and therefore the MP 151 starts garbage collection. That is, even when the logical capacity is 400 GB, if 100 GB is written, the performance deteriorates. Over Provisioning can reduce the logical capacity, increases the reserved region and improves the efficiency of garbage collection. The storage control apparatus 111 can configure the presence or absence of Over Provisioning of the SSD 132 based on input from the user.

In the SSD 132, Write Amplification (write amplification factor) is defined which the ratio of the number of pages of the FM 151 which is actually rewritten to the number of pages to be updated. Since an SSD having small Write Amplification can not only increase the random write speed but also avoid useless erasure or rewrite cycles, it also has excellent durability. When large-sized sequential write is performed, Write Amplification becomes substantially 1. On the other hand, when small-sized or random write is performed, Write Amplification differs depending on the type of SSD. Since much of write in transaction processing is normally small-sized, Write Amplification is an important index in expressing the system performance. The MP 151 measures Write Amplification and saves the measurement result in the shared memory 155.

Hereinafter, the drive management table 222 and the condition management table 223 will be described.

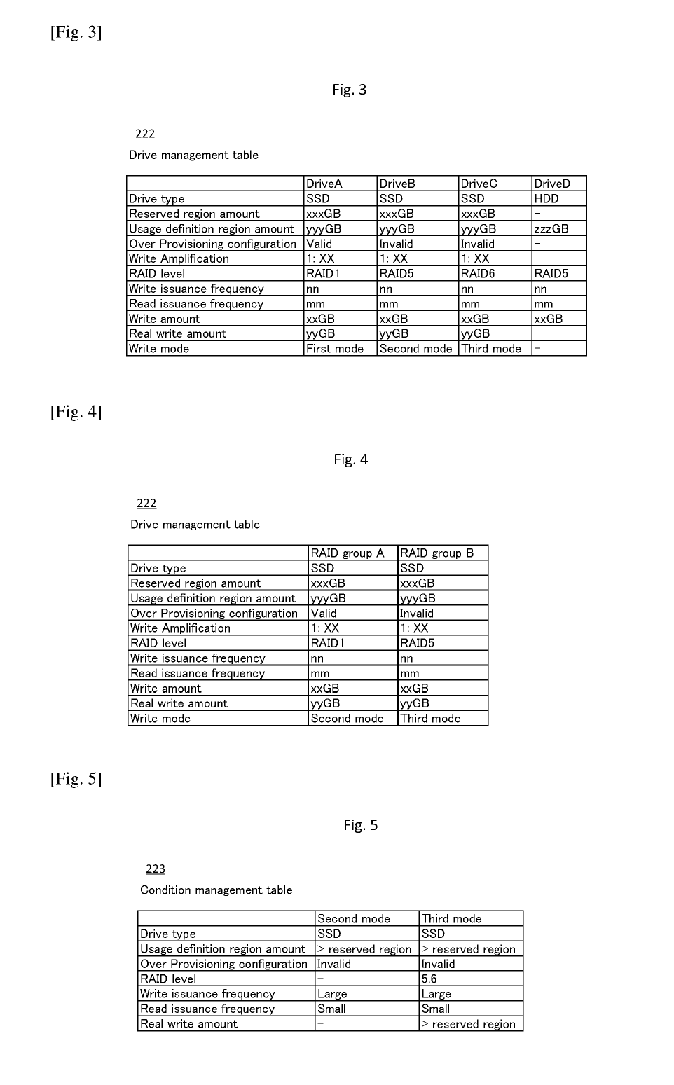

FIG. 3 illustrates contents of the drive management table 222. The MP 121 creates the drive management table 222 and saves it in the shared memory 125. The drive management table 222 stores drive information of each drive. The drive management table 222 in this example stores drive information of drives A, B, C and D. The drive information contains a plurality of parameters. Examples of the plurality of parameters include drive type, reserved region amount, usage definition region amount, Over Provisioning configuration, Write Amplification, RAID level, write issuance frequency, read issuance frequency, write amount, real write amount, and write mode.

The MP 121 acquires state information from the drive and saves the state information in the drive management table 222. The state information contains drive type, reserved region amount and Write Amplification. The drive type indicates whether the drive is an SSD or not. In other words, the drive type indicates whether the storage medium of the drive is a non-volatile memory or not. The reserved region amount indicates the size of the reserved region in the drive. Write Amplification indicates performance of the drive as described above.

Furthermore, the MP 121 creates configuration information indicating the configuration of the drive based on input or the like from the user and saves the configuration of the drive in the drive management table 222. The configuration information contains Over Provisioning configuration, usage definition region amount and RAID level. The Over Provisioning configuration is inputted to the storage control apparatus 111 beforehand by the user and indicates whether Over Provisioning is valid or not. The usage definition region amount may be a logical capacity of the drive. The RAID level is a RAID level of the RAID group to which the drive is assigned and indicates RAID 1, 5, 6 or the like. The configuration information may also contain an identifier of the RAID group to which the drive is assigned.

Furthermore, the MP 121 measures an IO situation corresponding to each drive every time an IO request is received from the host computer 133, creates IO information indicating the measurement result and saves the IO information in the drive management table 222. The IO information contains write issuance frequency, read issuance frequency, and real write amount. The write issuance frequency indicates the number of write commands issued to the drive per unit time. The read issuance frequency indicates the number of read commands issued to the drive per unit time. The value of real write amount indicates, when the drive is the SSD 132, the total amount of data actually written to the FM 154. Furthermore, the MP 121 saves the write mode configured in the drive in the drive management table 222.

When the drive type is an HDD, the drive information does not contain values of the reserved region, Over Provisioning configuration, Write Amplification, real write amount and write mode.

FIG. 4 illustrates contents of the drive management table 222 when managing the RAID group.

When a plurality of drives are assigned to the RAID group, the drive management table 222 stores drive information of the RAID group. The drive information of the RAID group is based on drive information of a plurality of drives contained in the RAID group. For example, the drive information of the RAID group may indicate the value of the drive information of drives included in the RAID group or may also indicate a total or average of values of the drive information of drives included in the RAID group.

FIG. 5 illustrates contents of the condition management table 223. This condition management table 223 stores a transition condition which is a condition under which a transition takes place to a second mode or a third mode. The transition condition includes a plurality of parameter conditions. The parameter condition is a condition of a parameter in the drive information and defines a value or range of the parameter. The plurality of parameter conditions are drive type, usage definition region amount, Over Provisioning configuration, RAID level, write issuance frequency, read issuance frequency and real write amount. When the drive information satisfies all parameter conditions within a certain transition condition, the drive information is decided to satisfy the transition condition.

The parameter condition for the drive type for the second mode and third mode is, for example, that the drive type should be an SSD. The parameter condition for the Over Provisioning configuration for the second mode and third mode is, for example, that Over Provisioning should be invalid. For the parameter condition of the write issuance frequency, ranges of “large” and “small” of a predetermined write issuance frequency are defined. The parameter condition for the write issuance frequency for the second mode and third mode is, for example, that the write issuance frequency should fall within a range of “large”. In other words, this parameter condition is that the write issuance frequency should be larger than a predetermined write issuance frequency threshold. For the parameter condition of the read issuance frequency, predetermined “large” and “small” ranges of read issuance frequency are defined. The parameter condition for the read issuance frequency for the second mode and third mode is, for example, that the read issuance frequency should fall within a “small” range. In other words, this parameter condition is that the read issuance frequency should be less than a predetermined read issuance frequency threshold. The parameter condition for the usage definition region amount for the second mode and third mode is, for example, that the usage definition region amount should be equal to or larger than the reserved region amount. The transition condition for the second mode and third mode may also include that the reserved region amount should be equal to or less than a predetermined threshold.

The parameter condition for the RAID level for the third mode is, for example, that the RAID level should be 5 or 6. The parameter condition for the real write amount for the third mode is, for example, that the real write amount should be equal to or larger than the reserved region amount. The parameter condition for the real write amount for the third mode may also be that the real write amount should be equal to or larger than a predetermined threshold. Furthermore, the transition condition may also include a Write Amplification condition.

According to the drive management table 222 and the condition management table 223, the MP 121 can determine a write mode in accordance with a situation such as drive type, usage definition region amount, Over Provisioning configuration, RAID level, write issuance frequency, read issuance frequency, real write amount, and reserved region amount. For example, when the write issuance frequency to the SSD 132 is high, the free space of the SSD 132 decreases and the SSD 132 executes internal processing of creating a free space.

Hereinafter, operation relating to write processing of the storage apparatus 110 will be described.

The MP 121 performs write mode determination processing of determining the write mode of a drive or RAID group and write mode execution processing of executing processing in a write mode in response to a write request.

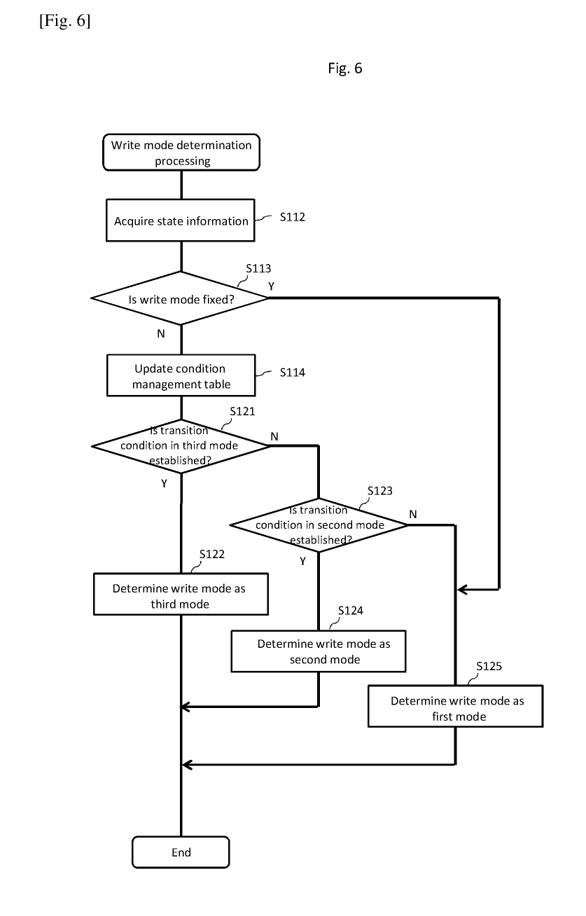

FIG. 6 illustrates write mode determination processing.

The MP 121 periodically performs write mode determination processing for each drive. Here, suppose the MP 121 sequentially selects a drive to be subjected to write mode determination processing as a target drive. Furthermore, the MP 121 performs write mode determination processing per RAID group on a drive belonging to a RAID group. In this case, the target drive is a RAID group which is the target of the write mode determination processing.

The MP 121 acquires state information from the target drive and updates the drive management table 222 with the acquired state information (S112). Here, the MP 121 transmits a request for state information to the target drive and receives state information from the target drive. When the target drive is a RAID group, the MP 121 acquires state information from all drives belonging to the RAID group and calculates state information of the RAID group based on the acquired state information. Here, the MP 121 may acquire part of the state information from the target drive. After that, the MP 121 decides whether the write mode is fixed or not (S113). Here, when the drive type of the target drive indicates an HDD or when the user configures the write mode as fixed beforehand, the MP 121 decides that the write mode is fixed.

When the write mode is decided to be fixed (S113: Y), the MP 121 configures the write mode of the target drive as the first mode (S125) and ends this flow. When the write mode is decided not to be fixed (S113: N), the MP 121 updates the condition management table 223 based on the drive management table 222 (S114). Here, the MP 121 configures the usage definition region amount condition and real write amount condition in the condition management table 223 using, for example, the value of the reserved region amount in the drive management table 222.

After that, the MP 121 decides whether the parameter of the target drive satisfies the transition condition for the third mode or not based on the drive management table 222 and the condition management table 223 (S121). When the parameter of the target drive is decided to satisfy the transition condition for the third mode (S121: Y), the MP 121 configures the write mode of the target drive as the third mode (S122) and ends the flow.

When the parameter of the target drive is decided not to satisfy the transition condition for the third mode (S121: N), the MP 121 decides whether the parameter of the target drive satisfies the transition condition for the second mode or not based on the drive management table 222 and the condition management table 223 (S123). When the parameter of the target drive is decided to satisfy the transition condition for the second mode (S123: Y), the MP 121 configures the write mode of the target drive as the second mode (S124) and ends this flow.

When the parameter of the target drive is decided not to satisfy the transition condition for the second mode (S123: N), the MP 121 configures the write mode of the target drive as the first mode (S125) and ends this flow.

According to the above-described write mode determination processing, it is possible to periodically select the write mode of the SSD 132 based on drive information. Even when different drive types coexist in the storage apparatus 110, this allows write processing of each drive to be optimized.

Upon receiving a write request to update the data stored in the storage apparatus 110 from the host computer 133, the MP 121 may also perform write mode determination processing.

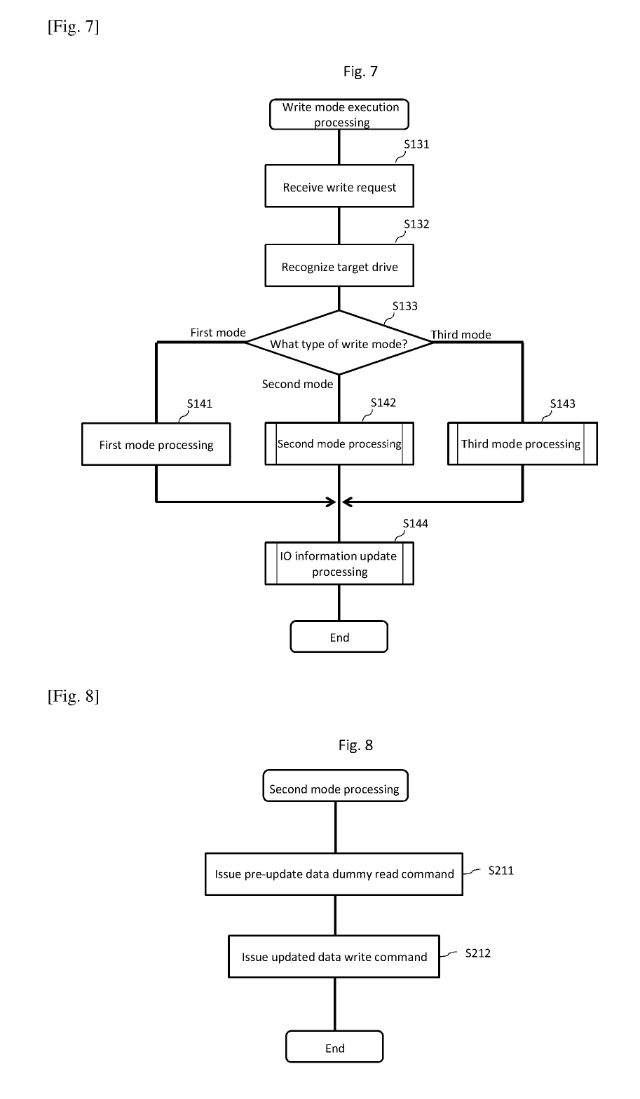

FIG. 7 illustrates the write mode execution processing.

When the host computer 133 transmits a write request to update the data stored in the storage apparatus 110 to the storage apparatus 110, the MP 121 performs write mode execution processing. The MP 121 receives the write request from the host computer 133 (S131). After that, the MP 121 recognizes the target drive which is the drive corresponding to the target address range of the write request based on the address management table 221 (S132). The target drive may be a RAID group. After that, the MP 121 decides, according to the drive management table 222, whether the write mode of the target drive is the first mode, second mode or third mode (S133).

When the write mode is the first mode (S133: first mode), the MP 121 performs first mode processing (S141) and moves the processing to S144. When the write mode is the third mode (S133: third mode), the MP 121 performs third mode processing (S143) and moves the processing to S144. When the write mode is the second mode (S133: second mode), the MP 121 performs second mode processing (S142) and moves the processing to S144.

Then, the MP 121 performs IO information update processing of updating the drive management table 222 based on the write result (S144) and ends this flow.

Hereinafter, the first mode processing, second mode processing and third mode processing will be described.

The first mode processing is normal write processing. The MP 121 issues a write command to a target drive based on a write request. As in the case of an initial state of the SSD 132, when there is a sufficient reserved region amount compared to the usage definition region amount or real write amount, the write mode is the first mode. After the write mode transitions to the second mode or third mode, when, for example, the write issuance frequency falls below a predetermined threshold, the write mode transitions to the first mode again.

FIG. 8 illustrates second mode processing.

The MP 121 recognizes a target data drive which is the SSD 132 storing pre-update data specified by the write request and a pre-update data range which is an address range including pre-update data in the target data drive, based on the address management table 221.

After that, the MP 121 issues a dummy read command for the pre-update data to the target data drive (S211). The dummy read command is similar to the read command, but the dummy read command does not require any response of the read data. The MP 151 that has received the dummy read command reads the pre-update data from the FM 151 to the cache memory 153 as in the case of a normal read command, but the read pre-update data is not transmitted to the MP 121. Even when the pre-update data in the FM 154 is fragmented, the read pre-update data is aligned and written to the cache memory 153.

When the pre-update data is read into the cache memory 153, the MP 121 issues a write command for the updated data to a target data drive (S212) and ends this flow. Thus, the MP 151 of the target data drive updates the pre-update data in the cache memory 153 with the updated data. After that, the MP 151 writes the updated data in the cache memory 153 to the FM 154 asynchronously with the reception of the write command.

While normal write processing does not issue any read command for the pre-update data, the second mode processing issues a dummy read command in the update target address range and stages the target address range to the cache memory 153 in the SSD 132. Thus, the storage control apparatus 111 performs only write to the cache memory 153, and can thereby perform write to the SSD 132 at a high speed. Furthermore, the storage control apparatus 111 can improve a cache hit rate in the SSD 132 and reduce the number of write operations to the FM 154.

Furthermore, since the pre-update data read from the FM 154 is aligned in the cache memory 153, the updated data in the cache memory 153 is also aligned and fragmentation can be avoided. Thus, during a rewrite to the FM 154 or subsequent rewrite, the number of blocks erased or the number of pages copied can be reduced compared to a case where the second mode processing is not used. Furthermore, since the updated data in the cache memory 153 is aligned, the speed of write to the FM 154 can be improved. Thus, the performance of access to the SSD 132 can be improved.

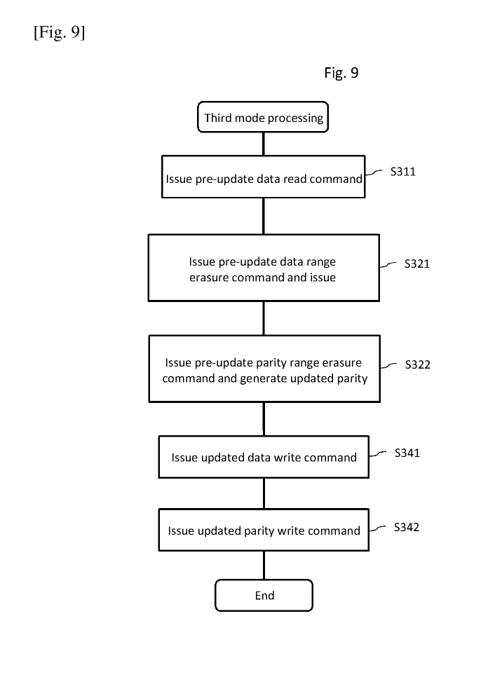

FIG. 9 illustrates third mode processing.

The MP 121 recognizes a target RAID group which is a RAID group for storing pre-update data specified in a write request and a target stripe which is a stripe containing the pre-update data in the target RAID group based on the address management table 221. Furthermore, the MP 121 recognizes a pre-update data range which is a strip containing the pre-update data in the target stripe, a pre-update parity range which is a strip containing a pre-update parity in the target stripe, a target data drive which is a drive containing a pre-update data range and a target parity drive which is a drive containing a pre-update parity range, based on the address management table 221. The target parity drive may be a device same as the target data drive, or may be a device different from the target data drive.

After that, the MP 121 issues a read command for the pre-update data to the target data drive (S311). When the pre-update data is read into the cache memory 123, the MP 121 issues an erasure command for the pre-update data range to the target data drive and the MP 121 issues a read command for the pre-update parity to the target parity drive (S321). In this way, erasure of the pre-update data range and read of the pre-update parity are performed in parallel, and a delay in the processing of the MP 121 caused by erasing the pre-update data range can thereby be suppressed. Furthermore, since the pre-update data range is erased after the pre-update data is read from the pre-update data range, the consistency of the RAID group can be maintained.

When the pre-update parity is read into the cache memory 123, the MP 121 issues an erasure command for the pre-update parity range to the target parity drive, generates an updated parity based on the read pre-update data and pre-update parity and writes the updated parity to the cache memory 123 (S322). In this way, erasure of the pre-update parity range and generation of the updated parity are performed in parallel, and a delay in the processing of the MP 121 caused by erasing the pre-update data range can thereby be suppressed. Furthermore, since the pre-update parity range is erased after the pre-update parity is read from the pre-update parity range, the consistency of the RAID group can be maintained.

When the updated parity is generated in the cache memory 123, the MP 121 issues a write command for the updated data to the target data drive (S341). When the updated data is written to the target data drive, the MP 121 issues a write command for the updated parity to the target parity drive (S342). When the updated parity is written to the target parity drive, the MP 121 ends this flow.

In aforementioned 5311, if the pre-update data is decided to be a cache hit stored in the cache memory 123, it is not necessary to issue a read command for the pre-update data to the target data drive. Furthermore, in aforementioned 5321, if the pre-update parity is decided to be a cache hit stored in the cache memory 123, it is not necessary to issue a read command for the pre-update parity to the target parity drive.

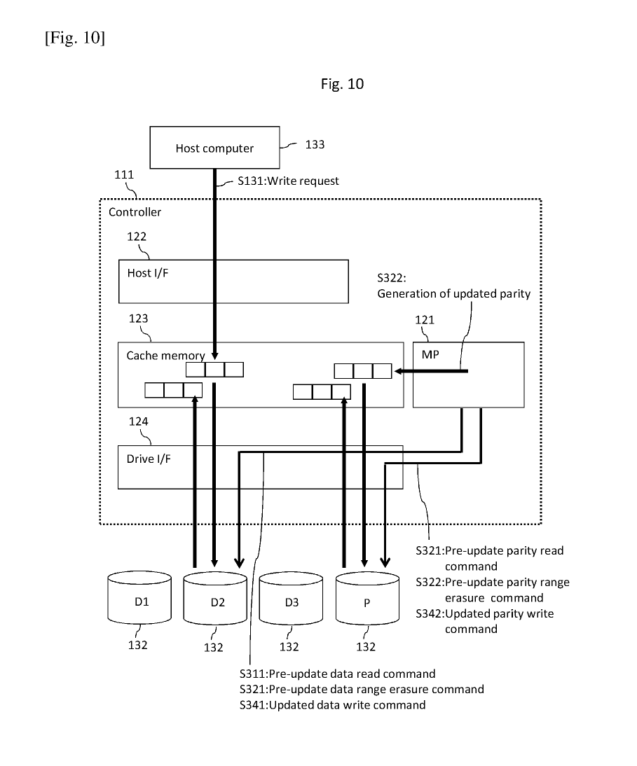

FIG. 10 schematically illustrates third mode processing in the RAID 5. Here, the MP 121 creates a RAID group of the RAID 5 using D1, D2, D3 and P which are four SSDs 132. Suppose the target data drive is D2 and the target parity drive is P with respect to a certain write request. The MP 121 issues an erasure command for the pre-update data (S321) after reading the pre-update data in D2 (S311) and issues an erasure command for the pre-update parity (S322) after reading the pre-update parity in P (S321). The consistency of the RAID group is maintained through this third mode processing.

The third mode processing in the RAID 6 will be described. Suppose the target data drive is D2 and the target parity drive is P and Q with respect to a certain write request. The MP 121 issues an erasure command of the pre-update data (S321) after reading the pre-update data in the target parity drive D2 (S311), issues an erasure command for the pre-update parity in P (S322) after reading the pre-update parity in P (S321) and issues an erasure command for the pre-update parity in Q (S322) after reading the pre-update parity in Q (S321). The consistency of the RAID group is maintained through this third mode processing.

The erasure command is a command for indicating a specified block in the FM 154 as a target of an erasure and is a command that urges the MP 151 to erase the target. The erasure command may also be a command for notifying erasure of an unnecessary address range to the MP 151 or a command instructing the MP 151 to erase an unnecessary address range. For example, a trim command is used as the erasure command. The trim command is defined in an ATA (Advanced Technology Attachment) standard. Here, suppose the OS (Operating System) of the host computer 133 and the SSD 132 support the trim command. The OS notifies the unnecessary block to the SSD 132 through the trim command. The MP 151 can execute garbage collection based on information of the trim command. This makes it possible to erase the block notified as unnecessary before the SSD 132 runs short of unused pages and an execution condition is established, and improve the access performance of the SSD 132. Garbage collection, which is internal processing upon establishment of the execution condition, copies the data stored in the FM 154, whereas garbage collection based on the trim command does not copy the data notified as unnecessary, and it is thereby possible to generate an unused page at a high speed. This makes it possible to prevent the write speed from decreasing and improve the efficiency of wear leveling. Wear leveling levels out the number of rewrites in the FM 154 and suppresses deterioration of the FM 154.

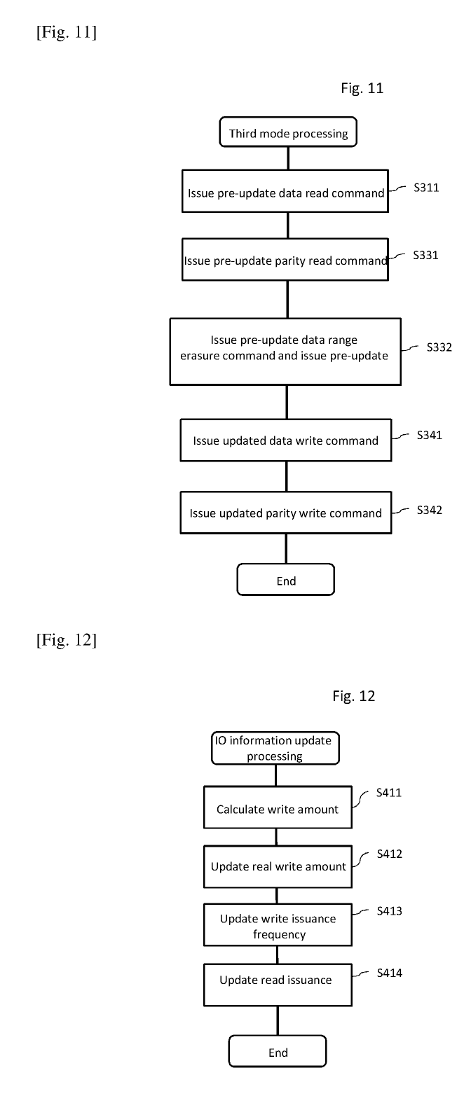

FIG. 11 illustrates a modification example of the third mode processing. In the modification example of the third mode processing, elements of processing identical to or corresponding to the elements of the third mode processing are assigned identical reference numerals and descriptions thereof will be omitted.

When the pre-update data is read into the cache memory 123 in aforementioned S311, the MP 121 issues a pre-update parity read command to the target parity drive (S331). When the pre-update parity is read into the cache memory 123, the MP 121 issues a pre-update data range erasure command to the target data drive, issues a pre-update parity range erasure command to the target parity drive and generates an updated parity based on the read pre-update data and pre-update parity (S332). In this way, erasure of the pre-update data range, erasure of the pre-update parity range and generation of the updated parity are performed in parallel, and a delay in the processing of the MP 121 caused by erasing the pre-update data range and erasing the pre-update parity range can thereby be suppressed. Furthermore, since the pre-update data range and the pre-update parity range are erased after reading the pre-update data from the pre-update data range and reading the pre-update parity from the pre-update parity range, the consistency of the RAID group can be maintained. Thus, the processing sequence in the third mode processing can be changed so as to maintain the consistency of the RAID group.

When the updated parity is generated into the cache memory 123, the MP 121 performs aforementioned 5341 and 5342, and ends this flow.

According to the above-described third mode, when the MP 121 issues an erasure command to a certain SSD 132, commands and parities or the like for other SSDs 132 are generated in parallel, and overhead by erasure commands can thereby be suppressed. Furthermore, the MP 121 issues a command for erasing the range read into the cache memory 123 to the SSD 132, and thereby maintains the consistency of the RAID group. In the event of trouble with the SSD 132, this allows data to be recovered using the RAID.

The transition condition for the second mode and the transition condition for the third mode in the condition management table 223 are established before the garbage collection execution condition in the MP 151 is established. This makes it possible to improve the efficiency of garbage collection and prevent the access performance of the SSD 132 from deteriorating.

When the drive information of the SSD 132 satisfies the second mode or third mode transition condition, the storage control apparatus 111 issues a read command to the SSD 132, then issues a write command to the SSD 132, and the storage control apparatus 111 can thereby update the data read into the cache memory 153 or the cache memory 123. This allows the write performance of the SSD 132 to be improved.

FIG. 12 illustrates IO information update processing.

The MP 121 calculates the write amount which is the size of write data contained in a write request (S411). Then, the MP 121 multiplies the write amount by Write Amplification of the target drive, thereby calculates a real write amount and the drive management table 222 updates the real write amount of the target drive (S412). After that, the MP 121 adds the number of write commands issued to the target drive during the write mode execution processing to the write issuance frequency of the target drive in the drive management table 222 (S413). After that, the MP 121 adds the number of read commands issued to the target drive during the write mode execution processing to the read issuance frequency of the target drive in the drive management table 222 (S414), and ends this flow.

According to the above IO information update processing, it is possible to reflect the IO situation for each drive in the drive information and determine the write mode of the SSD 132 based on the IO situation.

The MP 121 may cause the display apparatus to display a management screen for managing the storage apparatus 110. The management screen accepts ON or OFF input of an Over Provisioning configuration of each drive based on, for example, the operation by the user. Furthermore, the management screen may also display a transition condition or accept input of a transition condition. Furthermore, the management screen may also display drive information or part thereof.

The drive information may contain information indicating the model name or the generation of the SSD 132 to distinguish the write performance and read performance of the SSD 132 and the transition condition may contain conditions of the model name and the generation. In this way, the write mode determination processing allows only the SSD 132 having write performance and read performance higher than predetermined performance to transition to the second mode or third mode. Furthermore, the drive information may contain a free slot amount (Write Pending rate) of the cache memory 123 or cache memory 153 and the transition condition may contain conditions of free slots. Thus, the write mode determination processing can decide, according to the free slot amount of the cache memory 153, whether or not to cause the write mode to transition to the second mode and decide, according to the free slot amount of the cache memory 123, whether or not to cause the write mode to transition to the third mode.

When the SSD 132 spontaneously performs garbage collection upon establishment of an execution condition, the performance of the storage apparatus 110 deteriorates during the garbage collection. The storage control apparatus 111 instructs the garbage collection at appropriate timing, and can thereby suppress performance deterioration of the storage apparatus 110. Since data to be frequently updated is stored in the cache memory 153, the data can be updated in the cache memory 153. This reduces the amount of write to the FM 154. Such an operation provides room for performance of the SSD 132 and suppresses performance deterioration of the storage apparatus 110 even when the garbage collection is executed.

According to the present embodiment, it is possible to realize stabilization and leveling with respect to access performance such as response of the SSD 132. As the capacity of storage increases, the page size or block size also increases, and therefore overhead associated with erasure processing of the SSD is assumed to increase. According to the present embodiment, it is possible to detect timing of performance deterioration of the SSD 132 based on the drive information of the SSD 132, change write processing on the SSD 132, and thereby prevent performance deterioration of the SSD 132.

The technique described in the above-described embodiments can be expressed as follows.

(Expression 1)

A storage apparatus comprising:
a controller coupled to a host computer;
a memory coupled to the controller; and
a drive coupled to the controller,
the drive including:
a drive control device coupled to the controller and configured to control the drive; and
a non-volatile memory coupled to the drive control device,
wherein the memory is configured to store drive information including a situation of write to the drive,
the controller is configured to decide whether or not the drive information satisfies a first condition,
when the drive information is decided to satisfy the first condition and the controller receives from the host computer a write request instructing the controller to update first data stored in the drive to second data, the controller transmits to the drive control device a first read command instructing the drive control device to read the first data from the non-volatile memory in accordance with the write request, and
after the transmission of the first read command, the controller transmits to the drive control device a first write command instructing the drive control device to write the second data to the drive in accordance with the write request.

(Expression 2)

A storage apparatus according to expression 1, further comprising a cache memory coupled to the controller,
wherein after the first data is read from the drive to the cache memory in response to the first read command, the controller transmits to the drive control device a first notification command indicating an address range including an address of the first data in the drive as a target of an erasure.

(Expression 3)

A storage apparatus according to expression 2, wherein the controller is configured to create a RAID group using the drive;
the drive is configured to store a first parity based on the first data;
after the first data is read from the drive to the cache memory in response to the first read command, the controller transmits to the drive control device a second read command instructing the drive control device to read the first parity from the drive; and
after the first parity is read from the drive to the cache memory in response to the second read command, the controller transmits to the drive control device a second notification command indicating an address range including an address of the first parity in the drive as a target of an erasure.

(Expression 4)

A storage apparatus according to expression 3, wherein the drive information includes RAID level information indicating a RAID level of the RAID group, and
the first condition includes that the RAID level information indicates a predetermined RAID level.

(Expression 5)

A storage apparatus according to expression 4, wherein each of the first notification command and the second notification command notifies an unnecessary address range.

(Expression 6)

A storage apparatus according to expression 5, wherein the drive control device erases the first parity in the non-volatile memory in accordance with the second notification command,
when the drive control device erases the first parity, the controller generates a second parity based on the first data, the first parity, and the second data in the cache memory, and
the controller transmits to the drive control device a second write command instructing the drive control device to write the second parity to the drive.

(Expression 7)

A storage apparatus according to expression 6, wherein the drive control device erases the first data in the non-volatile memory in accordance with the first notification command, and
when the drive control device erases the first data, the drive control device transmits the first parity to the cache memory in accordance with the second read command.

(Expression 8)

A storage apparatus according to expression 4,
wherein the drive further includes a drive cache memory coupled to the drive control device,
the controller is configured to decide whether or not the drive information satisfies a second condition,
when the drive information is decided to satisfy the second condition and the controller receives the write request from the host computer, the controller transmits to the drive control device a third read command instructing the drive control device to read the first data from the non-volatile memory to the drive cache memory in accordance with the write request,
the drive control device reads the first data from the non-volatile memory and writes the first data to the drive cache memory in response to the third read command,
after the transmission of the third read command, the controller transmits to the drive control device a third write command instructing the drive control device to write the second data to the drive, and
the drive control device rewrites the first data in the drive cache memory to the second data in response to the third write command.

(Expression 9)

A storage apparatus according to expression 1,
wherein the drive further includes a drive cache memory coupled to the drive control device,
the first read command is configured to instruct the drive control device to read the first data from the non-volatile memory to the drive cache memory,
the drive control device is configured to read the first data from the non-volatile memory and write the first data to the drive cache memory in response to the first read command, and
the drive control device is configured to rewrite the first data in the drive cache memory to the second data in response to the first write command.

(Expression 10)

A storage apparatus according to expression 1,
wherein the drive information is configured to include a drive type indicating whether a storage medium of the drive is the non-volatile memory or not, and
the first condition is configured to include that the drive type indicates the non-volatile memory.

(Expression 11)

A storage apparatus according to expression 1,
wherein the drive information is configured to include a reserved region amount of the drive and a state amount indicating the state of the drive, and
the first condition is configured to include that the reserved region amount is less than the state amount.

(Expression 12)

A storage apparatus according to expression 11, wherein the state amount is a logical capacity of the drive.

(Expression 13)

A storage apparatus according to expression 11, wherein the state amount is an amount of accumulated data written to the non-volatile memory.

(Expression 14)

A storage apparatus according to expression 1,
wherein the drive information is configured to include a write command issuance frequency indicating a frequency with which write commands are issued to the drive, and
the first condition is configured to include that the write issuance frequency is larger than a predetermined threshold.

(Expression 15)

A storage apparatus control method for controlling a storage apparatus including a controller coupled to a host computer, a memory coupled to the controller, and a drive coupled to the controller, the drive including a drive control device coupled to the controller and configured to control the drive, and a non-volatile memory coupled to the drive control device, the method comprising:
storing, in the memory, drive information including a situation of write to the drive; deciding, by the controller, whether the drive information satisfies a first condition or not;
when the drive information is decided to satisfy the first condition and the controller receives from the host computer a write request instructing the controller to update the first data stored in the drive to second data, transmitting, by the controller, to the drive control device a first read command instructing the drive control device to read the first data from the non-volatile memory in accordance with the write request; and
after the transmission of the first read command, transmitting, by the controller, to the drive control device a first write command instructing the drive control device to write the second data to the drive in accordance with the write request.

The terms used in the above expressions will be described. The controller corresponds to the MP 121 or the like. The memory corresponds to the shared memory 125 or the like. The drive corresponds to the SSD 132 or the like. The drive control device corresponds to the MP 151 or the like. The non-volatile memory corresponds to the FM 154 or the like. The cache memory corresponds to the cache memory 123 or the like. The memory corresponds to the shared memory 125 or the like. The drive cache memory corresponds to the cache memory 153 or the like. The first condition corresponds to the transition condition for the third mode or second mode or the like. The second condition corresponds to the transition condition for the second mode or the like. The state amount corresponds to the usage definition region amount, real write amount or the like. The first read command corresponds to the read command for the pre-update data in the third mode, the dummy read command for the pre-update data in the second mode or the like. The first write command corresponds to the write command for the updated data in the third mode, the write command for the updated data in the second mode or the like. The first notification command corresponds to the erasure command for pre-update data range in the third mode or the like. The second read command corresponds to the read command for the pre-update parity in the third mode or the like. The second notification command corresponds to the erasure command for pre-update parity range in the third mode or the like. The second write command corresponds to the write command for the updated parity in the third mode or the like. The third read command corresponds to the dummy read command for the pre-update data in the second mode or the like. The third write command corresponds to the write command for the updated data in the second mode or the like.

### REFERENCE SIGNS LIST

110: storage apparatus, 111: storage control apparatus, 122: host I/F, 123: cache memory, 124: drive I/F, 125: shared memory, 131: HDD, 132: SSD, 133: host computer, 152: communication I/F, 153: cache memory, 155: shared memory, 211: storage apparatus control program, 221: address management table, 222: drive management table, 223: condition management table

1.-2. (canceled)

3. A storage apparatus comprising:
a controller coupled to a host computer;
a memory coupled to the controller; and
a drive coupled to the controller,
the drive including:
a drive control device coupled to the controller and configured to control the drive; and
a non-volatile memory coupled to the drive control device,
wherein the memory is configured to store drive information including a situation of write to the drive,
the controller is configured to decide whether or not the drive information satisfies a first condition,
when the drive information is decided to satisfy the first condition and the controller receives from the host computer a write request instructing the controller to update first data stored in the drive to second data, the controller is configured to transmit to the drive control device a first read command instructing the drive control device to read the first data from the non-volatile memory in accordance with the write request, and
after the transmission of the first read command, the controller is configured to transmit to the drive control device a first write command instructing the drive control device to write the second data to the drive in accordance with the write request;
a cache memory coupled to the controller,
wherein after the first data is read from the drive to the cache memory in response to the first read command, the controller is configured to transmit to the drive control device a first notification command indicating an address range including an address of the first data in the drive as a target of an erasure,
wherein the controller is configured to create a RAID group using the drive;
the drive is configured to store a first parity based on the first data;
after the first data is read from the drive to the cache memory in response to the first read command, the controller is configured to transmit to the drive control device a second read command instructing the drive control device to read the first parity from the drive; and
after the first parity is read from the drive to the cache memory in response to the second read command, the controller is configured to transmit to the drive control device a second notification command indicating an address range including an address of the first parity in the drive as a target of an erasure.

4. A storage apparatus according to claim 3, wherein the drive information includes RAID level information indicating a RAID level of the RAID group, and
the first condition includes that the RAID level information indicates a predetermined RAID level.

5. A storage apparatus according to claim 4, wherein each of the first notification command and the second notification command notifies an unnecessary address range.

6. A storage apparatus according to claim 5, wherein the drive control device is configured to erase the first parity in the non-volatile memory in accordance with the second notification command,
when the drive control device erases the first parity, the controller is configured to generate a second parity based on the first data, the first parity, and the second data in the cache memory, and
the controller is configured to transmit to the drive control device a second write command instructing the drive control device to write the second parity to the drive.

7. A storage apparatus according to claim 6, wherein the drive control device is configured to erase the first data in the non-volatile memory in accordance with the first notification command, and
when the drive control device erases the first data, the drive control device is configured to transmit the first parity to the cache memory in accordance with the second read command.

8. A storage apparatus according to claim 4,
wherein the drive further includes a drive cache memory coupled to the drive control device,
the controller is configured to decide whether or not the drive information satisfies a second condition,
when the drive information is decided to satisfy the second condition and the controller receives the write request from the host computer, the controller is configured to transmit to the drive control device a third read command instructing the drive control device to read the first data from the non-volatile memory to the drive cache memory in accordance with the write request,
the drive control device is configured to read the first data from the non-volatile memory and write the first data to the drive cache memory in response to the third read command,
after the transmission of the third read command, the controller is configured to transmit to the drive control device a third write command instructing the drive control device to write the second data to the drive, and
the drive control device is configured to rewrite the first data in the drive cache memory to the second data in response to the third write command.

9.-15. (canceled)
